(19) United States
(12) Patent Application Publication
(10) Pub. No.: US 2026/0001028 A1
(43) Pub. Date: Jan. 1, 2026

(54) METHODS AND SYSTEMS FOR PURIFYING CARBON DIOXIDE

(71) Applicant: Air Products and Chemicals, Inc., Allentown, PA (US)

(72) Inventors: Timothy Christopher Golden, Nevez (FR); Mozhgan Alimohammadi Zanjani, Flemington, NJ (US); Sujan Balendra, London (GB); William J. Casteel, Jr., Fountain Hill, PA (US); Garret C. Lau, New Tripoli, PA (US)

(73) Assignee: Air Products and Chemicals, Inc., Allentown, PA (US)

(21) Appl. No.: 18/754,619

(22) Filed: Jun. 26, 2024

(51) Int. Cl. B01D 53/04; B01D 53/26; B01D 53/52; B01D 53/75; B01D 53/82; C01B 32/50

(52) U.S. Cl. CPC B01D 53/0462; B01D 53/261; B01D 53/52; B01D 53/75; B01D 53/82; C01B 32/50; B01D 2253/108; B01D 2257/304; B01D 2257/406; B01D 2257/7027; B01D 2257/80

(57) ABSTRACT

A method may include passing a feed stream including carbon dioxide, water and one or more impurities over a first lean adsorbent bed to produce a dehydrated stream depleted in water and a first rich adsorbent bed enriched in water. The method may also include passing the dehydrated stream over a second lean adsorbent bed to produce a carbon dioxide product stream depleted in the one or more impurities and a second rich adsorbent bed enriched in the one or more impurities. The method may further include passing a first regeneration gas stream over the first rich adsorbent bed to produce a first spent regeneration gas stream enriched in water; and combining the first spent regeneration gas stream or a stream derived from the first spent regeneration gas stream with the feed stream.

### BACKGROUND

Industrial processes such as power generation and hydrogen production will need to capture carbon dioxide (CO2) to mitigate the effects of climate change. Captured CO2 may require dehydration and purification prior to sequestration or utilization to remove impurities such as water, alcohols, aromatics, volatile hydrocarbons, sulfur oxides, and nitrogen oxides. One method of purification is temperature swing adsorption (TSA) in which a CO2 feed stream is passed over an adsorbent bed to remove impurities such as water. Once the adsorbent bed is loaded with impurities it may be taken offline and regenerated by heating and passing a clean regeneration gas, such as product CO2 over the adsorbent bed to remove the impurities. The resulting spent regeneration gas comprising CO2 and impurities must be managed to maximize overall CO2 recovery and prevent buildup of impurities.

### SUMMARY

Disclosed herein is an example of methods and systems for purifying a feed stream comprising CO2 by adsorbing water vapor and one or more impurities. The method may include contacting the feed stream with a first adsorbent bed selective for water, then with a second adsorbent bed selective for the one or more impurities. The method may further include passing a first regeneration gas over a first adsorbent bed rich with water to produce a first spent regeneration gas enriched in water which may then be combined with the feed stream after an optional condensation step to remove water.

The system may include a first lean adsorbent bed with a first adsorbent bed selective for water and a second lean adsorbent bed selective for the one or more impurities. The system may further include a first rich adsorbent bed configured to accept a first regeneration gas stream and produce a first spent regeneration gas stream enriched in water. The outlet of the first rich adsorbent bed may be in fluid flow communication with an inlet of the first lean adsorbent bed.

It is to be understood that both the foregoing general description and the following detailed description are exemplary and explanatory in nature and are intended to provide an understanding of the present disclosure without limiting the scope of the present disclosure. In that regard, additional aspects, features, and advantages of the present disclosure will be apparent to one skilled in the art from the following detailed description.

### BRIEF DESCRIPTION OF DRAWINGS

These drawings illustrate certain aspects of some of the embodiments of the present disclosure and should not be used to limit or define the disclosure.

FIG. 1 is a schematic illustration depicting an embodiment of a CO2 purification process according to one or more aspects of the present disclosure.

FIG. 2 is a schematic illustration depicting a modification of FIG. 1 in which a second stage adsorption unit comprises a disposable getter.

### DETAILED DESCRIPTION

The present disclosure is directed to methods and systems for purifying a feed stream comprising CO2, water and one or more impurities is disclosed herein. The impurities may comprise sulfur oxides, nitrogen oxides, C5+ hydrocarbons, H2S, COS, CO, aromatic hydrocarbons, HCN, ammonia, amines, glycols, alcohols, ketones, aldehydes, acids, ethers, and combinations thereof.

In accordance with the present embodiments, water may be removed from the feed stream in a first adsorption unit, producing a dehydrated CO2 stream. If present, ammonia may also be removed in the first adsorption unit. The feed stream may be at a temperature ranging from 5° C. to 50° C. (41° F. to 122° F.), or 20° C. to 40° C. (68° F. to 104° F.), and a pressure ranging from 10 to 70 bar (145 to 1015 psi), or 25 to 50 bar (362 to 725 psi). The feed stream may comprise at least 50% by volume CO2, or at least 80% by volume CO2, or at least 99% by volume CO2. The feed stream may comprise water ranging from 100 ppmv to 1.3 vol %, or from 1000 ppmv to 4000 ppmv. The feed stream may comprise the one or more impurities less than 500 ppmv, or less than 200 ppmv, or less than 100 ppmv. The dehydrated CO2 stream may comprise less than 100 ppmv water, or less than 20 ppmv water, or less than 1 ppmv water, or less than 0.1 ppmv water. The first adsorption unit may comprise a first temperature swing adsorption (TSA) unit comprising multiple beds comprising a first adsorbent selective for water. The first adsorbent may have a low dynamic capacity for the one or more impurities. The first adsorbent may have a dynamic capacity for the one or more impurities of less than 5%, or less than 1%. The first adsorbent may have pores sized to accept water and exclude larger molecules such as the one or more impurities. The first adsorbent may have pore sizes ranging from 0.26 nm to 0.4 nm. The first adsorbent may have pore sizes smaller than the kinetic diameter of the one or more impurities. The first adsorbent may be a 3 A molecular sieve zeolite. If the first adsorbent is 3 A, it may be at least 60% exchanged with potassium, may comprise 10% or less binder (binder may comprise silica or silicone). The first adsorbent may comprise zeolites such as RHO, CHA, ITQ, analcime, bikitaite, erionite, ZK-5, merlinoite, phillipsite, yugawaralite, titanosilicates, or combinations thereof.

A second adsorption unit may remove one or more impurities from the dehydrated CO2 stream, producing a product CO2 stream. The total concentration of the one or more impurities in the product CO2 stream may be less than 500 ppmv, or less than 100 ppmv, or less than 50 ppmv, or less than 10 ppmv, or less than 1 ppmv. The second adsorption unit may comprise a second TSA unit comprising multiple beds comprising a second adsorbent selective for the one or more impurities. The second adsorbent may have pore sizes greater than 0.4 nm, or pore sizes ranging from 0.4 nm to 6 nm. The second adsorbent may comprise 4 A, AW-500, NaY, activated carbon, silica gel, zeolites, activated alumina, metal organic frameworks, or combinations thereof. The second adsorption unit may comprise a disposable chemisorbent that may be replaced with fresh chemisorbent when laden with one or more impurities. The disposable chemisorbent may comprise copper supported on a framework to react with H2S to produce CuS and H2.

The first TSA may be regenerated in a closed loop using a first regeneration gas stream. The first regeneration gas stream may comprise a portion of the product CO2 stream. The first regeneration gas may comprise a portion of the feed stream. The first TSA may be configured such that a bed rich in water is configured to receive the first regeneration gas stream while a bed lean in water is configured to receive the feed stream. The first TSA may have a bed on-stream (defined as the period of time in which a bed receives the feed stream and produces a dehydrated CO2 stream) for a period of time ranging from 2 to 24 hours, or from 4 hours to 12 hours. The first regeneration gas stream may be heated and passed over the first adsorbent after it has become laden with water to drive water off the first adsorbent and produce a first spent regeneration gas. The first adsorbent may be heated by indirectly transferring heat through the walls of the TSA. The target temperature to regenerate the first TSA may range from 150° C. to 300° C. (302° F. to 572° F.), or from 150° C. to 200° C. (302° F. to 392° F.). The first spent regeneration gas may be cooled to partially condense at least a portion of the water which may be separated and removed as a liquid condensate stream. The first spent regeneration gas stream may be combined with the feed stream or recycled to the inlet of the first TSA to improve overall CO2 recovery. The first TSA may be regenerated at a pressure near the pressure of the feed stream to reduce or eliminate the power required to recycle the first spent regeneration gas stream. The pressure of the first regeneration gas stream may be within 5 bar of the pressure of the feed stream, or within 1.5 bar of the pressure of the feed stream.

The second TSA may be regenerated in an open loop using a portion of the product CO2 stream. In an open loop configuration, the spent regeneration gas is not recycled, which may result in CO2 losses. An open loop may be required for the second TSA because the one or more impurities may have a high vapor pressure which would prevent the one or more impurities from being removed in a condenser. For example, benzene has a relatively high vapor pressure which would accumulate in a recycle loop if a condenser was the only way for benzene to leave the system. A portion of the product CO2 stream may be divided to form a second regeneration gas stream. The second TSA may be configured such that a bed rich in one or more impurities is configured to receive the second regeneration gas stream while a bed lean in one or more impurities is configured to receive the dehydrated CO2 stream. The second TSA may have a bed on-stream for a period of time ranging from 1 day to 30 days, or from 5 days to 30 days. The second regeneration gas stream may be heated and passed over the second adsorbent after it has become laden with water to drive one or more impurities off the second adsorbent and produce a second spent regeneration gas. The second adsorbent may be heated by indirectly transferring heat through the walls of the TSA. The target temperature to regenerate the second TSA may range from 150° C. to 300° C. (302° F. to 572° F.). The second spent regeneration gas may be delivered to a vent, thermal oxidizer, or combustion process such as a burner in a steam methane reformer. The second spent regeneration gas may be treated with a liquid scrubber prior to venting as required by emission regulations. The second TSA may be regenerated at a pressure near ambient pressure to facilitate desorption of one or more impurities and decrease the contact time during desorption to help avoid unwanted side reactions like benzene cracking. The second regeneration gas stream may be within 5 bar of ambient pressure, or within 1.5 bar of ambient pressure, or within 0.2 bar of ambient pressure.

Regenerating a TSA requires elevated temperatures, which may lead to unwanted side reactions between impurities as they are driven off the adsorbent bed. An unexpected advantage of using two TSAs in series is that since water is removed in the first TSA, any unwanted side reactions between water and the one or more impurities may be prevented in the second spent regeneration gas. For example, alkenes may react with water to form alcohols, or sulfur and nitrogen oxides may react with water to form acids. In at least some embodiments, unwanted side reactions may involve reactions that produce rather than consume water, such as dehydration of alcohols to form ethers, in which case the regeneration gas stream may comprise water greater than 10 ppmv, or greater than 50 ppmv, or ranging from 10 ppmv to 2000 ppmv, or ranging from 50 ppmv to 2000 ppmv, in order to slow any side reactions of the one or more impurities that produce water.

The ratio of on-stream time for the second TSA divided by the on-stream time for the first TSA may range from 2 to 360, or from 10 to 60. The second TSA may be held on-stream for a longer time than the first TSA because of the water removal in the first TSA. The second TSA therefore may require much less gas required for regeneration, reducing CO2 losses. In cases where the second adsorption unit comprises a second TSA regenerated with an open loop, the overall CO2 recovery may be greater than 95%, or greater than 99%, or greater than 99.5%. In cases where the second adsorption unit comprises a disposable chemisorbent, no regeneration gas is required and the overall CO2 recovery may be essentially 100%. A disposable chemisorbent may be on-stream for a period ranging from 4 to 12 months before replacement.

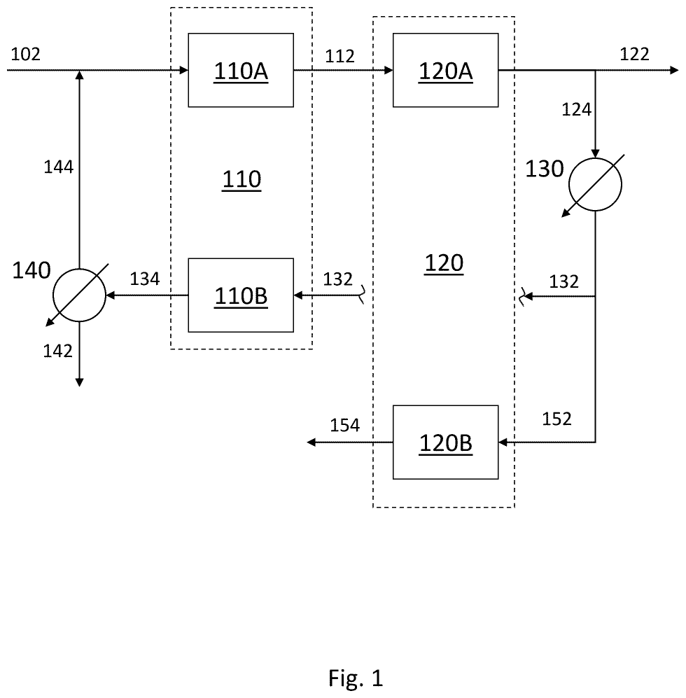

FIG. 1 is a schematic illustration depicting an embodiment of a CO2 purification process according to one or more aspects of the present disclosure. A feed stream 102 comprising carbon dioxide, water, and one or more impurities comprising sulfur oxides, nitrogen oxides, C5+ hydrocarbons, H2S, COS, CO, aromatic hydrocarbons, HCN, ammonia, amines, glycols, alcohols, ketones, aldehydes, acids, ethers, and combinations thereof, enters a first lean bed 110A (lean with respect to water) of a first TSA 110. The first lean bed 110A may comprise a first adsorbent selective to water, removing water from the feed stream 102 and producing a dehydrated CO2 stream 112 depleted in water. The first adsorbent may be size selective to only accept water molecules into the pores and let the one or more impurities pass into the dehydrated CO2 stream 112. The dehydrated CO2 stream 112 may then enter a second lean bed 120A (lean with respect to the one or more impurities) of a second TSA 120. The second lean bed 120A may comprise a second adsorbent selective to the one or more impurities, removing the one or more impurities from the dehydrated CO2 stream 112 and producing a product CO2 stream 122 depleted in the one or more impurities.

At least a portion of the product CO2 stream 122 may be divided to form a regeneration gas stream 124 which may be heated in heater 130 to form a first regeneration gas stream 132. The first regeneration gas stream 132 may be passed over a first rich bed 110B (rich with respect to water) in the first TSA 110 to desorb water from the first adsorbent, regenerating the first rich bed 110B and producing a first spent regeneration gas 134 enriched in water. The first spent regeneration gas may be cooled in chiller 140 to partially condense water which may be removed as liquid condensate stream 142. An overhead stream 144 may exit the chiller 140 and be combined with the feed stream 102. At least a portion of the first regeneration gas stream 132 may be divided to form a second regeneration gas stream 152. The second regeneration gas stream 152 may be passed over a second rich bed 120B (rich with respect to the one or more impurities) of the second TSA 120 to desorb the one or more impurities from the second rich bed 120B, regenerating the second rich bed 120B and producing a second spent regeneration gas stream 154. The second spent regeneration gas stream may be delivered to a vent, thermal oxidizer, or combustion process such as a burner in a steam methane reformer (not shown). The second spent regeneration gas may be treated with a liquid scrubber (not shown) prior to venting as required by emission regulations.

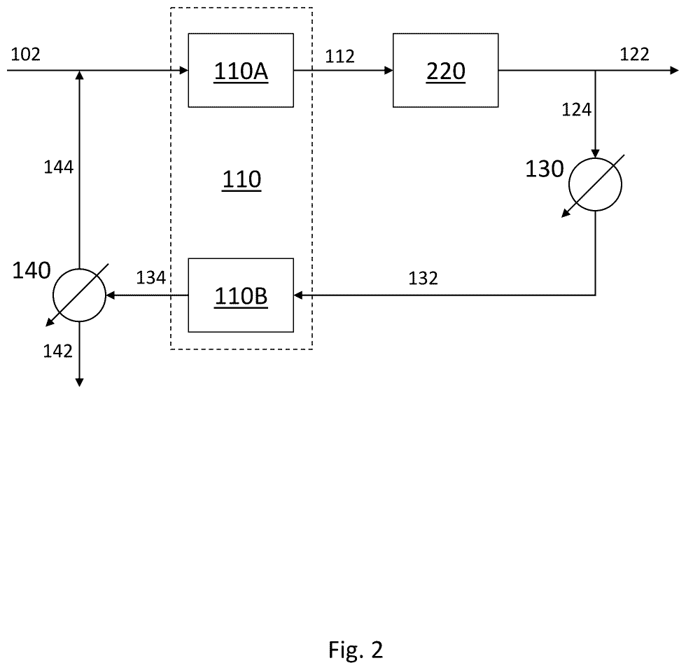

FIG. 2 is a schematic illustration depicting a modification of FIG. 1 in which a second stage adsorption unit comprises a disposable getter 220. The disposable getter 220 is replaced when it becomes enriched in the one or more impurities, so the spent regeneration gas 124 is only used to regenerate the first rich bed 110B.

Aspect 1: A method comprising passing a feed stream comprising carbon dioxide, water, and one or more impurities over a first lean adsorbent bed to produce a dehydrated stream depleted in water and a first rich adsorbent bed enriched in water; passing the dehydrated stream over a second lean adsorbent bed to produce a carbon dioxide product stream depleted in the one or more impurities and a second rich adsorbent bed enriched in the one or more impurities; passing a first regeneration gas stream over the first rich adsorbent bed to produce a first spent regeneration gas stream enriched in water and the first lean adsorbent bed; and combining the first spent regeneration gas stream or a stream derived from the first spent regeneration gas stream with the feed stream.

Aspect 2: A method according to Aspect 1, wherein the feed stream is passed over the first lean adsorbent bed at a first pressure; wherein the first regeneration gas is passed over the first rich adsorbent bed at a second pressure; wherein the first pressure is within 5 bar of the second pressure.

Aspect 3: A method according to Aspect 1 or 2, further comprising passing a second regeneration gas stream over the second rich adsorbent bed at a third pressure to produce a second spent regeneration gas stream enriched in the one or more impurities and the second lean adsorbent bed depleted in the one or more impurities; wherein the third pressure is within 5 bar of ambient pressure.

Aspect 4: A method according to any of Aspects 1 to 3, wherein the first lean adsorbent bed comprises a material with a pore size ranging from 0.26 nm to 0.4 nm.

Aspect 5: A method according to any of Aspects 1 to 4, wherein the first lean adsorbent bed comprises a material with a pore size smaller than the kinetic diameter of the one or more impurities.

Aspect 6: A method according to any of Aspects 1 to 5, wherein the second lean adsorbent bed comprises a material with a pore size greater than 0.4 nm.

Aspect 7: A method according to any of Aspects 1 to 6, wherein the first lean adsorbent bed comprises 3 A zeolites, RHO zeolites, CHA zeolites, ITQ zeolites, analcime zeolites, bikitaite zeolites, erionite zeolites, ZK-5 zeolites, merlinoite zeolites, phillipsite zeolites, yugawaralite zeolites, and small pore titanosilicates, or combinations thereof.

Aspect 8: A method according to any of Aspects 1 to 7, wherein the second lean adsorbent bed comprises 4 A, AW-500, NaY, silica gel, activated carbon, activated alumina or metal organic frameworks, or combinations thereof.

Aspect 9: A method according to any of Aspects 1 to 8, wherein the second lean adsorbent bed comprises a disposable chemisorbent.

Aspect 10: A method according to any of Aspects 1 to 9, wherein the further comprising partially condensing the first spent regeneration gas to remove a liquid condensate stream prior to combining the first spent regeneration gas with the feed stream.

Aspect 11: A method according to any of Aspects 1 to 10, wherein a ratio of an on-stream time for the second lean adsorbent bed divided by an on-stream time for the first lean adsorbent bed ranges from 2 to 360.

Aspect 12: A method according to any of Aspects 1 to 11, wherein the molar flow rate of carbon dioxide in the carbon dioxide product divided by the molar flow rate of carbon dioxide in the feed stream is greater than or equal to 0.95.

Aspect 13: A method according to any of Aspects 1 to 12, wherein the first regeneration gas stream comprises a portion of the carbon dioxide product stream, a portion of the feed stream, or combinations thereof.

Aspect 14: A method according to any of Aspects 1 to 13, wherein the one or more impurities comprises sulfur oxides, nitrogen oxides, C5+ hydrocarbons, H2S, COS, CO, aromatic hydrocarbons, HCN, ammonia, amines, glycols, alcohols, ketones, aldehydes, acids, ethers, or combinations thereof.

Aspect 15: A method comprising passing a feed stream comprising carbon dioxide, water, and one or more impurities over a first lean adsorbent bed at a first pressure to produce a dehydrated stream depleted in water and a first rich adsorbent bed enriched in water; passing the dehydrated stream over a second lean adsorbent bed to produce a carbon dioxide product stream depleted in the one or more impurities and a second rich adsorbent bed enriched in the one or more impurities; passing a first regeneration gas stream over the first rich adsorbent bed at a second pressure to produce a first spent regeneration gas stream enriched in water and the first lean adsorbent bed; partially condensing the first spent regeneration gas to produce a liquid condensate stream and an overhead stream; and combining the overhead with the feed stream; wherein the first lean adsorbent bed comprises a material with a pore size smaller than the kinetic diameter of the one or more impurities.

Aspect 16: A method according to Aspect 15, wherein the feed stream is passed over the first lean adsorbent bed at a first pressure; wherein the first regeneration gas is passed over the first rich adsorbent bed at a second pressure; wherein the first pressure is within 5 bar of the second pressure.

Aspect 17: A method according to Aspect 15 or 16, further comprising passing a second regeneration gas stream over the second rich adsorbent bed at a third pressure to produce a second spent regeneration gas stream enriched in the one or more impurities and the second lean adsorbent bed depleted in the one or more impurities; wherein the third pressure is within 5 bar of ambient pressure.

Aspect 18: A method according to any of Aspects 15 to 17, wherein the first lean adsorbent bed comprises 3 A zeolites, RHO zeolites, CHA zeolites, ITQ zeolites, analcime zeolites, bikitaite zeolites, erionite zeolites, ZK-5 zeolites, merlinoite zeolites, phillipsite zeolites, yugawaralite zeolites, and small pore titanosilicates, or combinations thereof.

Aspect 19: A method according to any of Aspects 15 to 18, wherein the second lean adsorbent bed comprises 4 A, AW-500, NaY, silica gel, activated carbon, activated alumina, metal organic frameworks, or combinations thereof.

Aspect 20: A method according to any of Aspects 15 to 19, wherein a ratio of an on-stream time for the second lean adsorbent bed divided by an on-stream time for the first lean adsorbent bed ranges from 2 to 360.

Aspect 21: A method according to any of Aspects 15 to 20, wherein the first regeneration gas stream comprises a portion of the carbon dioxide product stream, a portion of the feed stream, or combinations thereof.

Aspect 22: A method according to any of Aspects 15 to 21, wherein the one or more impurities comprise sulfur oxides, nitrogen oxides, C5+ hydrocarbons, H2S, COS, CO, aromatic hydrocarbons, HCN, ammonia, amines, glycols, alcohols, ketones, aldehydes, acids, ethers, or combinations thereof.

Aspect 23: A system comprising a first lean adsorbent bed configured to receive a feed stream comprising carbon dioxide, water, and one or more impurities to produce a dehydrated stream depleted in water; a second lean adsorbent bed in fluid flow communication with the first lean adsorbent bed configured to receive the dehydrated stream and produce a carbon dioxide product stream; a first rich adsorbent bed configured to accept a first regeneration gas stream and produce a first spent regeneration gas stream enriched in water; wherein an outlet of the first rich adsorbent bed is in fluid flow communication with an inlet of the first lean adsorbent bed.

Aspect 24: A system according to Aspect 23, wherein the first lean adsorbent bed comprises a material with a pore size ranging from 0.26 nm to 0.4 nm.

Aspect 25: A system according to Aspect 23 or 24, wherein the first lean adsorbent bed comprises a material with a pore size smaller than the kinetic diameter of the one or more impurities.

Aspect 26: A system according to any of Aspects 23 to 25, wherein the second lean adsorbent bed comprises a material with a pore size greater than 0.4 nm.

Aspect 27: A system according to any of Aspects 23 to 26, wherein the first lean adsorbent bed comprises 3 A zeolites, RHO zeolites, CHA zeolites, ITQ zeolites, analcime zeolites, bikitaite zeolites, erionite zeolites, ZK-5 zeolites, merlinoite zeolites, phillipsite zeolites, yugawaralite zeolites, and small pore titanosilicates, or combinations thereof.

Aspect 28: A system according to any of Aspects 23 to 27, wherein the second lean adsorbent bed comprises 4 A, AW-500, NaY, silica gel, activated carbon, activated alumina or metal organic frameworks, or combinations thereof.

Aspect 29: A system according to any of Aspects 23 to 28, wherein the one or more impurities comprise sulfur oxides, nitrogen oxides, C5+ hydrocarbons, H2S, COS, CO, aromatic hydrocarbons, HCN, ammonia, amines, glycols, alcohols, ketones, aldehydes, acids, and ethers, or combinations thereof.

Aspect 30: A system according to any of Aspects 23 to 29, further comprising a condenser in fluid flow communication with the outlet of the first rich adsorbent bed and the inlet of the first lean adsorbent bed.

The ensuing detailed description provides preferred exemplary embodiments only, and is not intended to limit the scope, applicability, or configuration of the disclosure. Rather, the ensuing detailed description of the preferred exemplary embodiments will provide those skilled in the art with an enabling description for implementing the preferred exemplary embodiments of the disclosure. Various changes may be made in the function and arrangement of elements without departing from the spirit and scope of the disclosure, as set forth in the appended claims.

The articles “a” or “an” as used herein mean one or more when applied to any feature in embodiments of the present disclosure described in the specification and claims. The use of “a” and “an” does not limit the meaning to a single feature unless such a limit is specifically stated. The article “the” preceding singular or plural nouns or noun phrases denotes a particular specified feature or particular specified features and may have a singular or plural connotation depending upon the context in which it is used.

The term “and/or” placed between a first entity and a second entity includes any of the meanings of (1) only the first entity, (2) only the second entity, or (3) the first entity and the second entity. The term “and/or” placed between the last two entities of a list of 3 or more entities means at least one of the entities in the list including any specific combination of entities in this list. For example, “A, B and/or C” has the same meaning as “A and/or B and/or C” and comprises the following combinations of A, B and C: (1) only A, (2) only B, (3) only C, (4) A and B but not C, (5) A and C but not B, (6) B and C but not A, and (7) A and B and C.

The term “plurality” means “two or more than two.”

The adjective “any” means one, some, or all, indiscriminately of quantity.

The phrase “at least a portion” means “a portion or all.” The “at least a portion of a stream” has the same composition, with the same concentration of each of the species, as the stream from which it is derived.

As used herein, “first,” “second,” “third,” etc. are used to distinguish among a plurality of steps and/or features, and is not indicative of the total number, or relative position in time and/or space, unless expressly stated as such.

The terms “depleted” or “lean” mean having a lesser mole percent concentration of the indicated component than the original stream from which it was formed. “Depleted” and “lean” do not mean that the stream is completely lacking the indicated component.

The terms “rich” or “enriched” mean having a greater mole percent concentration of the indicated component than the original stream from which it was formed.

“Downstream” and “upstream” refer to the intended flow direction of the process fluid transferred. If the intended flow direction of the process fluid is from the first device to the second device, the second device is downstream of the first device. In case of a recycle stream, downstream and upstream refer to the first pass of the process fluid.

### Example

The performance of a process for purifying carbon dioxide was simulated using proprietary software that solves the heat, mass, and momentum balances in an adsorption bed. This software package was used for all examples to come. Specifics of the simulation package can be found in Kumar et al, Chemical Engineering Science, 49(18), 3115, 1994. The software was used to compare a process using two TSAs in series according to FIG. 1, a process using a single TSA with a closed loop regeneration cycle and a process using a single TSA with an open loop regeneration cycle.

A feed stream at 30 bar (435 psi) and 30° C. (86° F.) comprising 2200 ppmv water and 10 ppmv benzene with a balance CO2 is purified to 10 ppmv water and 1 ppmv benzene in both cases. The size of the adsorbent bed required is sized to maximize overall CO2 recovery. In both cases the first spent regeneration gas is cooled to 30° C. (86° F.) prior to recycle. In the single TSA closed loop case benzene is present in the first spent regeneration gas, which causes benzene to accumulate in the feed to the TSA to 4200 ppmv. The high level of benzene requires larger beds than the two TSA case and shortens the lifetime of the adsorbent due to side reactions during regeneration. In the single TSA open loop case the volume of bed required and the adsorbent lifetime are roughly the same as the two TSA case, but the overall CO2 recovery drops to 84%.

TABLE 1

| | Relative TSA | CO2 | Adsorbent |
|---|---|---|---|
| Case | Bed Volume | Recovery | Lifetime (y) |
| Two TSA (FIG. 1) | 1.0 | 99.5% | 3 |
| Single bed closed loop | 5.5 | 100% | 2 |
| Single bed open loop | 0.89 | 84% | 3 |

While the principles of the disclosure have been described above in connection with preferred embodiments, it is to be clearly understood that this description is made only by way of example and not as a limitation of the scope of the disclosure.

1. A method comprising:
passing a feed stream comprising carbon dioxide, water, and one or more impurities over a first lean adsorbent bed to produce a dehydrated stream depleted in water and a first rich adsorbent bed enriched in water;
passing the dehydrated stream over a second lean adsorbent bed to produce a carbon dioxide product stream depleted in the one or more impurities and a second rich adsorbent bed enriched in the one or more impurities;
passing a first regeneration gas stream over the first rich adsorbent bed to produce a first spent regeneration gas stream enriched in water and the first lean adsorbent bed; and
combining the first spent regeneration gas stream or a stream derived from the first spent regeneration gas stream with the feed stream.

2. The method of claim 1, wherein the feed stream is passed over the first lean adsorbent bed at a first pressure;
wherein the first regeneration gas is passed over the first rich adsorbent bed at a second pressure;
wherein the first pressure is within 5 bar of the second pressure.

3. The method of claim 1, further comprising passing a second regeneration gas stream over the second rich adsorbent bed at a third pressure to produce a second spent regeneration gas stream enriched in the one or more impurities and the second lean adsorbent bed depleted in the one or more impurities;
wherein the third pressure is within 5 bar of ambient pressure.

4. The method of claim 1, wherein the first lean adsorbent bed comprises a material with a pore size smaller than the kinetic diameter of the one or more impurities.

5. The method of claim 1, wherein the first lean adsorbent bed comprises 3 A zeolites, RHO zeolites, CHA zeolites, ITQ zeolites, analcime zeolites, bikitaite zeolites, erionite zeolites, ZK-5 zeolites, merlinoite zeolites, phillipsite zeolites, yugawaralite zeolites, and small pore titanosilicates, or combinations thereof.

6. The method of claim 1, wherein the second lean adsorbent bed comprises 4 A, AW-500, NaY, silica gel, activated carbon, activated alumina, metal organic frameworks, or combinations thereof.

7. The method of claim 1, further comprising partially condensing the first spent regeneration gas to remove a liquid condensate stream prior to combining the first spent regeneration gas with the feed stream.

8. The method of claim 1, wherein a ratio of an on-stream time for the second lean adsorbent bed divided by an on-stream time for the first lean adsorbent bed ranges from 2 to 360.

9. The method of claim 1, wherein the first regeneration gas stream comprises a portion of the carbon dioxide product stream, a portion of the feed stream, or combinations thereof.

10. The method of claim 1, wherein the one or more impurities comprise sulfur oxides, nitrogen oxides, C5+ hydrocarbons, H2S, COS, CO, aromatic hydrocarbons, HCN, ammonia, amines, glycols, alcohols, ketones, aldehydes, acids, ethers, or combinations thereof.

11. A method comprising:
passing a feed stream comprising carbon dioxide, water, and one or more impurities over a first lean adsorbent bed at a first pressure to produce a dehydrated stream depleted in water and a first rich adsorbent bed enriched in water;
passing the dehydrated stream over a second lean adsorbent bed to produce a carbon dioxide product stream depleted in the one or more impurities and a second rich adsorbent bed enriched in the one or more impurities;
passing a first regeneration gas stream over the first rich adsorbent bed at a second pressure to produce a first spent regeneration gas stream enriched in water and the first lean adsorbent bed;
partially condensing the first spent regeneration gas to produce a liquid condensate stream and an overhead stream; and
combining the overhead with the feed stream;
wherein the first lean adsorbent bed comprises a material with a pore size smaller than the kinetic diameter of the one or more impurities.

12. The method of claim 11, wherein the feed stream is passed over the first lean adsorbent bed at a first pressure;
wherein the first regeneration gas is passed over the first rich adsorbent bed at a second pressure;
wherein the first pressure is within 5 bar of the second pressure.

13. The method of claim 11, further comprising passing a second regeneration gas stream over the second rich adsorbent bed at a third pressure to produce a second spent regeneration gas stream enriched in the one or more impurities and the second lean adsorbent bed depleted in the one or more impurities;
wherein the third pressure is within 5 bar of ambient pressure.

14. The method of claim 11, wherein the first lean adsorbent bed comprises 3 A zeolites, RHO zeolites, CHA zeolites, ITQ zeolites, analcime zeolites, bikitaite zeolites, erionite zeolites, ZK-5 zeolites, merlinoite zeolites, phillipsite zeolites, yugawaralite zeolites, and small pore titanosilicates, or combinations thereof.

15. The method of claim 11, wherein the second lean adsorbent bed comprises 4 A, AW-500, NaY, silica gel, activated carbon, activated alumina, metal organic frameworks, or combinations thereof.

16. The method of claim 11, wherein a ratio of an on-stream time for the second lean adsorbent bed divided by an on-stream time for the first lean adsorbent bed ranges from 2 to 360.

17. The method of claim 11, wherein the first regeneration gas stream comprises a portion of the carbon dioxide product stream, a portion of the feed stream, or combinations thereof.

18. The method of claim 11, wherein the one or more impurities comprise sulfur oxides, nitrogen oxides, C5+ hydrocarbons, H2S, COS, CO, aromatic hydrocarbons, HCN, ammonia, amines, glycols, alcohols, ketones, aldehydes, acids, ethers, or combinations thereof.

19. A system comprising:
a first lean adsorbent bed configured to receive a feed stream comprising carbon dioxide, water, and one or more impurities to produce a dehydrated stream depleted in water;
a second lean adsorbent bed in fluid flow communication with the first lean adsorbent bed configured to receive the dehydrated stream and produce a carbon dioxide product stream;
a first rich adsorbent bed configured to accept a first regeneration gas stream and produce a first spent regeneration gas stream enriched in water;
wherein an outlet of the first rich adsorbent bed is in fluid flow communication with an inlet of the first lean adsorbent bed.

20. The system of claim 19, further comprising a condenser in fluid flow communication with the outlet of the first rich adsorbent bed and the inlet of the first lean adsorbent bed.
